(19) United States
(12) Patent Application Publication
(10) Pub. No.: US 2004/0113622 A1
(43) Pub. Date: Jun. 17, 2004

(54) Active damping for open MRI image stabilization

(76) Inventors: Huageng Luo, Clifton Park, NY (US); Daniel Arthur Staver, Colorado Springs, CO (US); Darren Lee Hallman, Clifton Park, NY (US); Walter John Smith, Ballston Spa, NY (US)

Correspondence Address: General Electric Company, CRD Patent Docket Rm 4A59, Bldg. K-1, P.O. Box 8, Schenectady, NY, 12301, US

(21) Appl. No.: 10/318,895

(22) Filed: Dec. 13, 2002

(51) Int. Cl. G01V 3/00

(52) U.S. Cl. 324/322

(57) ABSTRACT

A control instrumentation system is provided for active vibration reduction in an open MRI system. The control instrumentation system comprises a sensor coupled to a post of the open MRI system for detecting vibration signals and converting the vibration signal to a corresponding electrical signal, a digital signal processor implementing a control algorithm to process the electrical signal to generate a corresponding control signal and an actuator receiving the control signal and using the control signal to minimize the vibration of the system.

### BACKGROUND

The invention relates generally to magnet resonance imager (MRI) systems, and more specifically to method and apparatus for active damping for open MRI images.

Typically, Magnet Resonance Imager (MRI) systems are cylindrical in shape. To increase the accessibility to patients, new designs such as open MRI have been introduced. Typically, an open MRI system consists of a top magnet and a bottom magnet. The magnets are connected to each other by posts (usually two) to increase the openness between the two magnets.

One problem with the above system is that since the two posts are located within 180° of the magnet circumference (to increase the patient scan swing angle), the magnet supports are not axially symmetric. Also, the top magnet center of the gravity is not aligned with the post supports. It is desirable to have the posts confined to as narrow an angular region as possible to enhance the openness of the MRI system. Narrow posts, however, are prone to vibration, which in turn affects imaging. In addition, the vibration of the posts causes a non-uniform magnetic field.

Usually, in high field MRI systems, the weight of a magnet is substantial. There is a potentially wide weight range, but for illustrative purposes a magnet of approximately 10,000 pounds is not unusual. The weight of the magnets makes the system susceptible to any force excitations, including environmental vibration and imaging processing magnetic force excitations. When the relative motion between the magnets exceeds certain limits, the image quality is significantly deteriorated.

In such environments, vibration of support posts may be detected during imaging with a fast spin echo sequence. The effect is caused by the periodic application of imaging gradients that produce a resonance with the mechanical systems of the MRI system. As the support posts bend slightly, the magnetic field in the imaging volume is perturbed, which is undesirable.

Thus, there is a need for a closed-loop control system to reduce vibration in an open MRI system. To ensure good image quality, it would also be desirable to increase the equivalent system damping so that disturbances can be damped out quickly and amplitudes can be reduced.

### SUMMARY OF THE INVENTION

Briefly, in accordance with one embodiment of the invention, a control instrumentation system is provided for active vibration reduction in an open MRI system. The system comprises a sensor coupled to a post of the open MRI system. The sensor detects vibration signals and converts the vibration signal to a corresponding electrical signal. A digital signal processor coupled to the sensor implements a control algorithm to process the electrical signal and generates a corresponding control signal. An actuator coupled to the digital signal processor, receives the control signal and uses the control signal to minimize the vibration of the system.

In another embodiment, a method for detecting and minimizing the effects of vibration in an open magnet MRI system is provided. The method comprises detecting a vibration signal, converting the vibration signal to a corresponding electrical signal, implementing a control algorithm to process the electrical signal and generate a corresponding control signal and using the control signal to minimize the effects of vibration of the system.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic perspective view of an embodiment of the magnet of the invention;

FIG. 2 is a schematic cross sectional view of the magnet of FIG. 1 taken along lines 2-2 of FIG. 1; and,

FIG. 3 is a block diagram illustrating an embodiment of a control instrumentation system.

### DETAILED DESCRIPTION

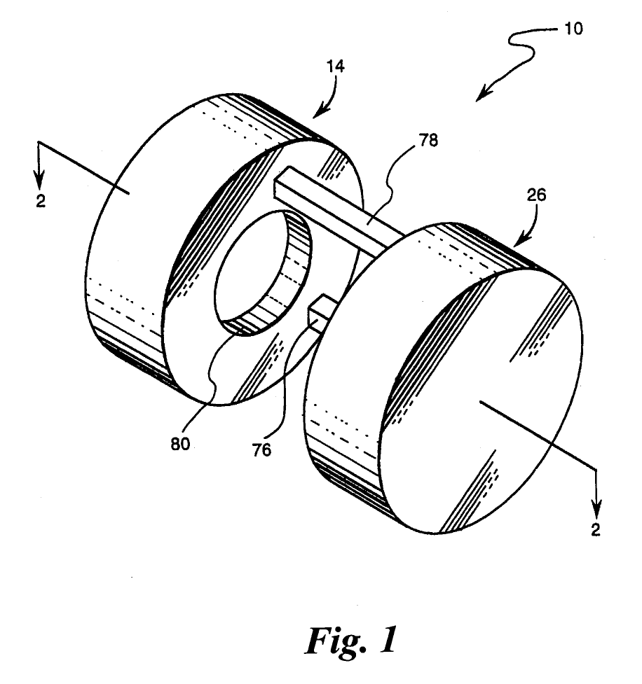

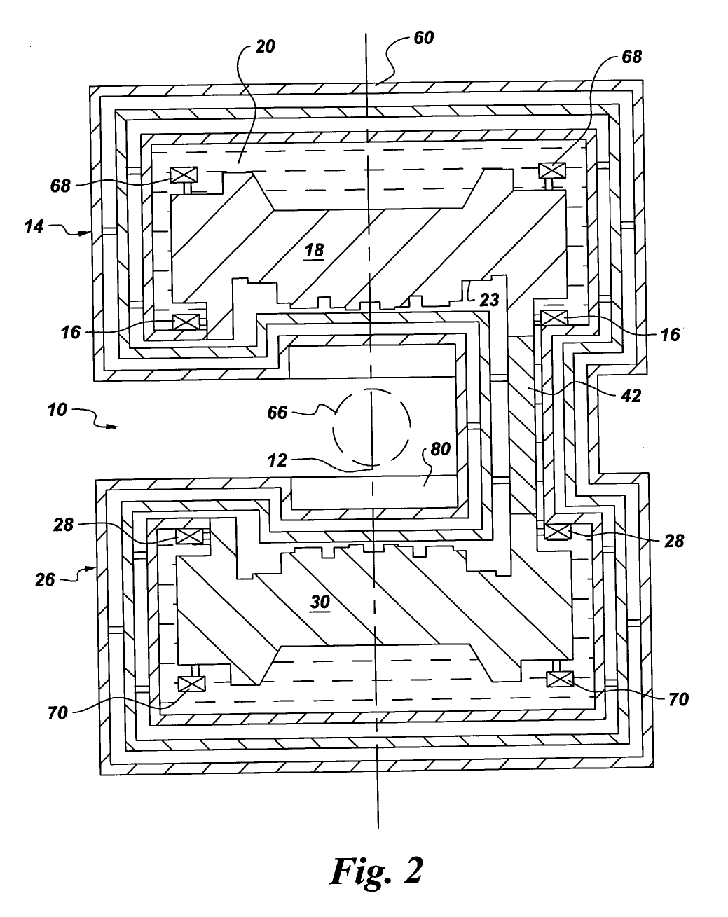

FIG. 1 is a schematic perspective view of an embodiment of the magnets of an open MRI system. Referring now to the drawings, wherein like numerals represent like elements throughout, FIGS. 1-2 show an embodiment of the magnet 10 of the present invention. In one application, magnet 10 provides the static magnetic field for a magnetic resonance imaging (MRI) system (not shown) used in medical diagnostics. It is noted that in describing the invention, when a magnet is said to include a component such as a coil, a pole piece, or a dewar, etc., it is understood to mean that the magnet includes at least one coil, at least one pole piece, or at least one dewar, etc.

In a first embodiment, a superconductive magnet 10 includes a longitudinally extending axis 12 and a first assembly 14. The first assembly 14 includes a superconductive main coil 16 and a magnetizable pole piece 18. The main coil 16 is generally coaxially aligned with the axis 12, carries a first main electric current in a first direction, and is disposed a first radial distance from the axis 12. The first direction is defined to be either a clockwise or a counterclockwise circumferential direction about the axis 12 with any slight longitudinal component of current direction being ignored. The pole piece 18 is generally coaxially aligned with the axis 12, and is spaced apart from the main coil 16 of the first assembly 14. Most of the pole piece 18 of the first assembly 14 is disposed radially inward of the main coil 16 of the first assembly 14. The pole piece 18 of the first assembly 14 extends from the axis 12 radially outward a distance equal to at least 75 percent of the first radial distance. During operation of the magnet 10, the pole piece 18 of the first assembly 14 has a temperature equal generally to that of the main coil 16 of the first assembly 14. It is noted that the first assembly 14 may be used alone as a table magnet (not shown) or may be one of two assemblies of an open magnet (as shown in the figures). During operation of the magnet 10, the main coil 16 and the pole piece 18 of the first assembly 14 are cooled by a cryocooler coldhead (not shown), and/or by a cryogenic fluid, or the like.

In one orientation of the open magnet 10, the first and second portions 76 and 78 of the vacuum vessel 60 are horizontally aligned (as shown in FIG. 1), and the patient would typically be in a standing position within the imaging volume 66. In another orientation (not shown) of the open magnet 10, the first and second portions 76 and 78 of the vacuum vessel 60 are vertically aligned, and the patient would typically be lying on a patient table within the imaging volume 66. It is noted that the pole pieces 18 and 30 provide the main structural support of the magnet 10 including the coils 16, 28, 68, and 70 and the dewars 20 and 32, and that the pole pieces 18 and 30 are shaped (e.g., have ring steps) to provide a more uniform magnetic field within the imaging volume 66.

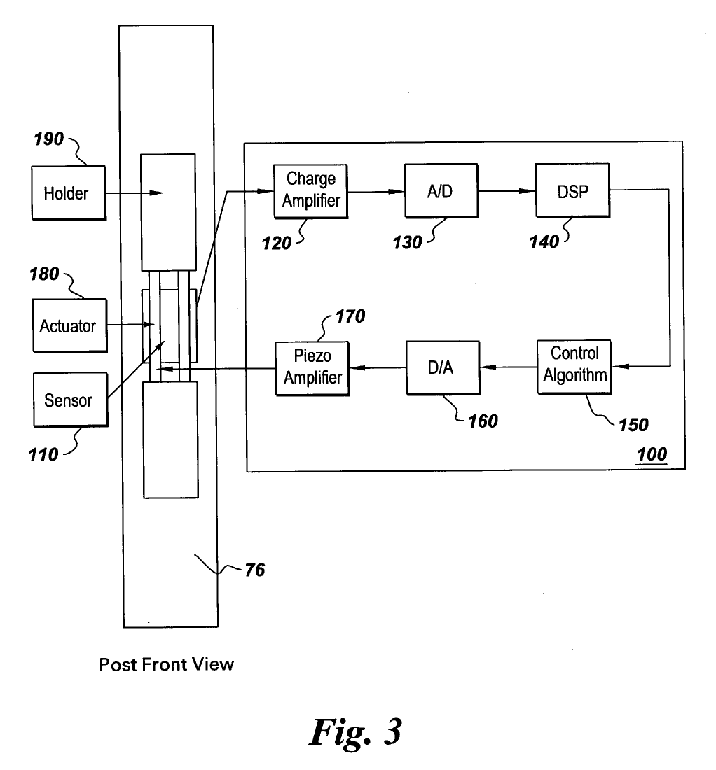

FIG. 3 is a block diagram of an embodiment of control instrumentation system implemented to reduce the active vibration system of the open MRI system of FIGS. 1 and 2. The control circuit 100 is coupled to sensor 110 and actuator 180. The control circuit comprises charge amplifier 120, analog to digital converter 130, digital signal processor 140, control algorithm 150, digital to analog converter 160, peizo amplifier 170. The control circuit 100 is configured for generating a control signal in response to vibration signals detected by the sensor in order to damp the vibration. The actuator is held in position by holder 190. Each component and the control algorithm are described in further detail below.

As used herein, “adapted to”, “configured” and the like refer to mechanical or structural connections between elements to allow the elements to cooperate to provide a described effect; these terms also refer to operation capabilities of electrical elements such as analog or digital computers or application specific devices (such as an application specific integrated circuit (ASIC)) that are programmed to perform a sequel to provide an output in response to given input signals.

Sensor 110 is coupled to a post of the open MRI system as shown in the figure. The sensor detects vibration signals of the post and converts the vibration signal to a corresponding electrical signal. In an embodiment, the electrical signal comprises an alternating current (ac) voltage signal. In the illustrated embodiment, the sensor is a lead zirconate titanate wafer stack. Other sensors that can sense vibration can be used including, for example, an accelerometer, a velocity sensor, a displacement sensor, or a strain gauge. It is to be appreciated that one skilled in the art of sensors would be able to select from a variety of known alternatives.

Charge amplifier 120 is coupled to the sensor and receives the electrical signal. The charge amplifier amplifies the electrical signal to a desired voltage level to generate an amplified electrical signal. In an embodiment the charge amplifier comprises custom designed to suit the sensor needs and the desired voltage is around 1.0 volt. Other ADC's known in the art can also be used.

Analog to digital converter (ADC) 130 is coupled to the charge amplifier and receives the amplified electrical signal. ADC 130 converts the amplified electrical signal to digital electric signal. In the illustrated embodiment ADC 130 comprises a National Instrument NI-6025E, which provides both A/D and D/A converters.

Digital signal processor 140 is coupled to the ADC and receives the digital electric signal. The digital signal processor implements a control algorithm 150 to process the digital electric signal to generate a corresponding control signal. In the illustrated embodiment, the control algorithm is based on the positive position feedback (PPF) control technique. It may be noted that for different sensors, the control algorithm needs to be modified accordingly. For example, if an accelerometer is used, the acceleration feed back control algorithm will be used, while if a velocity sensor is used, a velocity feed back control algorithm should be used. The design procedure for the PPF control technique is described below in further detail.

The single degree of freedom (DOF) equation for the PPF control of a structure consists of the structure modal equation with feedback and the compensator modal equation with sensing. The structure modal equation is given below:

$$\{ \begin{matrix}\ddot{ξ} + {β}_{s} \dot{ξ} + {ω}_{s}^{2} ( ξ - γ η ) = f ( t ) \\ \ddot{η} + {β}_{c} \dot{η} + {ω}_{c}^{2} ( η - ξ ) = 0\end{matrix} \qquad Equation ( 1 )$$

where ξ is the modal coordinate of the structure, βₛ=2δζₛωₛ; ζₛ is the structural damping ratio, ωₛ is the structural natural frequency, η is the modal coordinate of the compensator, β_{c}=2ζ_{c}ω_{c}, ζₛ is the compensator damping ratio, ωₛ is the compensator natural frequency, γ is the scalar gain applied to the feedback signal, f(t) is the forcing term.

In the Laplace domain, Equation (1) can be expressed as

$$\{ \begin{matrix}\overline{ξ} {s}^{2} + {β}_{s} \overline{ξ} s + {ω}_{s}^{2} ( \overline{ξ} - γ \overline{η} ) = \overline{f} \\ \overline{η} {s}^{2} + {β}_{c} \overline{η} s + {ω}_{c}^{2} ( \overline{η} - \overline{ξ} ) = 0\end{matrix} \qquad Equation ( 2 )$$

So that solving for η in the equation (2) and replacing its expression in the Equation (1), we obtain:

$$[ ( {s}^{2} + {β}_{s} s + {ω}_{s}^{2} ) - \frac{γ {ω}_{s}^{2} {ω}_{c}^{2}}{( {s}^{2} + {β}_{c} s + {ω}_{c}^{2} )} ] \overline{ξ} = \overline{f} \qquad Equation ( 3 )$$

Thus the characteristic equation of the system is:

(s²+βₛs+ωₛ²)(s²β_{c}s+ω_{c}²)−γωₛ²ω_{c}²=0 Equation (4)

The Routh arrays for the characteristic Equation (4) are:

$$\begin{matrix}1 & {ω}_{s}^{2} + {ω}_{c}^{2} + {β}_{s} {β}_{c} & {ω}_{s}^{2} {ω}_{c}^{2} ( 1 - γ ) \\ {β}_{s} + {β}_{c} & {β}_{s} {ω}_{c}^{2} + {β}_{c} {ω}_{s}^{2} & 0 \\ \frac{{β}_{s} {ω}_{s}^{2} + {β}_{c} {ω}_{c}^{2} + {β}_{s} {β}_{c} ( {β}_{s} + {β}_{c} )}{{β}_{s} + {β}_{c}} & {ω}_{s}^{2} {ω}_{c}^{2} ( 1 - γ ) & 0 \\ \frac{{β}_{s} {β}_{c} ( {( {ω}_{s}^{2} - {ω}_{c}^{2} )}^{2} + ( {β}_{s} + {β}_{c} ) ( {β}_{s} {ω}_{c}^{2} + {β}_{c} {ω}_{s}^{2} ) ) + {γ ( {β}_{s} + {β}_{c} )}^{2} {ω}_{s}^{2} {ω}_{c}^{2}}{{β}_{s} {ω}_{s}^{2} + {β}_{c} {ω}_{c}^{2} + {β}_{s} {β}_{c} ( {β}_{s} + {β}_{c} )} & 0 & 0 \\ {ω}_{s}^{2} {ω}_{c}^{2} ( 1 - γ ) & 0 & 0\end{matrix}$$

Since the elements of the first column have the same sign only if γ<1, the closed loop system is stable if γ<1.

In many applications, it is required that the introduction of the active vibration absorber should not introduce new vibration modes. This can be achieved by forcing the characteristic Equation (4) to have identical roots, that is

(s²+2ζₛωₛs+ωₛ²)(s²+2ζ_{c}ωₛs+ω_{c}²)−γωₛ²ω_{c}²=(s²+2ζ_{f}ω_{f}s+ω_{f}²)² Equation (5)

where ζf is the closed-loop system damping and (of is the closed-loop system frequency. Equating the terms of same power of s in Equation (5), we obtain the following equations:

$$\{ \begin{matrix}2 {ζ}_{f} {ω}_{f} = {ζ}_{s} {ω}_{s} + {ζ}_{c} {ω}_{c} \\ 2 {ω}_{f}^{2} + 4 {ζ}_{f}^{2} {ω}_{f}^{2} = {ω}_{s}^{2} + 4 {ζ}_{s} {ω}_{s} {ζ}_{c} {ω}_{c} + {ω}_{c}^{2} \\ 2 {ζ}_{f} {ω}_{f}^{3} = {ω}_{s}^{2} {ζ}_{c} {ω}_{c} + {ω}_{c}^{2} {ζ}_{s} {ω}_{s} \\ {ω}_{f}^{4} = {ω}_{s}^{2} {ω}_{c}^{2} ( 1 - γ )\end{matrix} \qquad Equations ( 6 ) , ( 7 ) , ( 8 ) and ( 9 )$$

From equations (6-9), the cross over conditions can be derived as

ωₛ²(1−ζₛ²)=ω_{c}²(1−ζ_{c}²) Equation (10)

or

ω_{c}ζ_{c}=ωₛζₛ Equation (11)

Assuming that the PPF compensator will be operated at the cross over point, a cross over condition can be chosen to design a compensator. To add damping in a structure without changing too much the natural frequency of the structure, we use the cross over condition Equation (6) which states that the damped natural frequencies of the structure and the compensator are the same. The condition fixes the first design parameter ωc to be

$${ω}_{c} = {ω}_{s} \frac{\sqrt{1 - {ζ}_{s}^{2}}}{\sqrt{1 - {ζ}_{c}^{2}}} \qquad Equation ( 12 )$$

Using this condition and Equation (6) and Equation (7), the closed loop natural frequency is:

$${ω}_{f} = {{ω}_{s} ( 1 - {ζ}_{s}^{2} + {ζ}_{s} {ζ}_{c} \frac{\sqrt{1 - {ζ}_{s}^{2}}}{\sqrt{1 - {ζ}_{c}^{2}}} )}^{\frac{1}{2}} \qquad Equation ( 13 )$$

Substituting Equation (13) in Equation (6), the gain of the compensator is:

$$γ = 1 - \frac{1 - {ζ}_{c}^{2}}{1 - {ζ}_{s}^{2}} {( 1 - {ζ}_{s}^{2} + {ζ}_{s} {ζ}_{c} \frac{\sqrt{1 - {ζ}_{s}^{2}}}{\sqrt{1 - {ζ}_{c}^{2}}} )}^{2} \qquad Equation ( 14 )$$

And finally, Equation (6) is:

$${ζ}_{f} = \frac{1}{2} \frac{( {ζ}_{s} + {ζ}_{c} \frac{\sqrt{1 - {ζ}_{s}^{2}}}{\sqrt{1 - {ζ}_{c}^{2}}} )}{{( 1 - {ζ}_{s}^{2} + {ζ}_{s} {ζ}_{c} \frac{\sqrt{1 - {ζ}_{s}^{2}}}{\sqrt{1 - {ζ}_{c}^{2}}} )}^{\frac{1}{2}}} \qquad Equation ( 15 )$$

Digital to analog converter 160 is coupled to the digital signal processor and receives the digital control signal. Digital to analog converter 160 converts the digital control signal to an analog control signal. In the illustrated embodiment, the digital to analog converter 160 comprises NI-6025E. Other known digital to analog converters can also be used.

Peizo amplifier 170 is coupled to the digital to analog converter to receive the analog control signal. The peizo electric amplifier amplifies the analog control signal to a desirable voltage. In the illustrated embodiment, the desirable voltage is determined by the control algorithm to minimize the sensor vibration.

Actuator 180 is coupled to the peizo amplifier and receives the analog control signal. The actuator uses the analog control signal to compensate and minimize the vibration of the open MRI system.

The previously described embodiments of the present invention have many advantages, including adding equivalent damping to the vibration mode. The mechanical vibration energy is dissipated through electronic devices. The control algorithm design being flexible can be designed to accommodate multi-mode control. Using this invention, the MRI image distortion due to environment and processing vibrations can be significantly reduced.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A control instrumentation system for active vibration reduction in an open Magnetic Resonance Imaging (MRI) system, said system comprising:
a sensor coupled to a post of the open MRI system, said sensor for detecting vibration signals and converting the vibration signals to a corresponding electrical signal; and
a control circuit coupled to said sensor, said control circuit configured for implementing a control algorithm to process the electrical signal to generate a corresponding control signal, the control signal being used for damping vibration of the open MRI system.

2. The control instrumentation system of claim 1, wherein said control circuit comprises a digital signal processor, the digital signal processor being configured to implement the control algorithm to process the electrical signal to generate the corresponding control signal.

3. The control instrumentation system of claim 1, further comprising an actuator coupled to the control circuit, the actuator configured for receiving the control signal and using the control signal to minimize the vibration of the open MRI system.

4. The control instrumentation system of claim 1, wherein the electrical signal is an alternating current (ac) voltage signal

5. The control instrumentation system of claim 1, wherein the sensor is selected from the group consisting of a lead zirconate titanate wafer stack, an accelerometer, a velocity sensor, a displacement sensor, and a strain gauge, each having a corresponding appropriate control algorithm modification.

6. The control instrumentation system of claim 1, wherein the control algorithm is selected from the techniques consisting of a positive position feedback control technique, a acceleration feed back control technique, a velocity feed back control technique.

7. The control instrumentation system of claim 1, further comprising a charge amplifier coupled to the sensor, the charge amplifier amplifying the electrical signal.

8. The control instrumentation system of claim 7, further comprising
an analog to digital converter converting the electrical signal to digital electric signal, the digital electric signal being provided to the digital signal processor to generate a digital control signal.

9. The control instrumentation system of claim 8, further comprising
a digital to analog converter coupled to the digital signal processor, the digital to analog converter receiving the digital control signal and generating the control signal.

10. The control instrumentation system of claim 9, further comprising
a peizo amplifier coupled to the digital to analog converter, the peizo electric amplifier amplifying the control signal and the control signal being provided to the actuator.

11. A method for detecting and minimizing the effects of vibration in an open magnet Magnetic Resonance Imaging (MRI) system, said method comprising:
detecting a vibration signal from a sensor attached to a support structure contained within the MRI system;
processing the vibration signal by implementing a control algorithm to damp the effects of vibration within the open MRI system.

12. The method of claim 11, wherein the control algorithm is selected from the techniques consisting of a positive position feedback control technique, a acceleration feed back control technique, a velocity feed back control technique.

13. The method of claim 11, wherein the processing comprises:
converting the vibration signal to a corresponding electrical signal; and
implementing the control algorithm to process the electrical signal and generate a corresponding control signal.

14. The method of claim 13, further comprising, receiving the control signal and using the control signal to minimize the vibration of the open MRI system.

15. The method of claim 13, wherein the electrical signal is an ac voltage signal.

16. The method of claim 13, further comprising, amplifying the electrical signal prior to implementing the control algorithm.

17. The method of claim 13, further comprising:
converting the electrical signal to a digital electric signal, the control algorithm being implemented on the digital electric signal to generate a digital control signal.

18. The method of claim 17, further comprising:
converting the digital control signal and generating the control signal.

19. The method of claim 11, further comprising:
amplifying the control signal, the control signal being used to minimize the effects of vibration.
